(19) United States
(12) Patent Application Publication
(10) Pub. No.: US 2025/0150887 A1
(43) Pub. Date: May 8, 2025

(54) HANDLING OF ADJACENT CHANNEL INTERFERENCE IN INDUSTRIAL ENVIRONMENT

(71) Applicant: Telefonaktiebolaget LM Ericsson (publ), Stockholm (SE)

(72) Inventors: Rong DU, Bromma (SE); Luis Felipe DEL CARPIO VEGA, Espoo (FI); Alexey SHAPIN, Luleå (SE); Dhruvin PATEL, Aachen (DE); Ajay KATTEPUR, Bangalore (IN)

(21) Appl. No.: 18/838,024

(22) PCT Filed: Feb. 14, 2022
(86) PCT No.: PCT/SE2022/050160

§ 371 Date: Aug. 13, 2024

(51) Int. Cl. H04W 28/02; H04B 7/06; H04L 1/00; H04W 72/121; H04W 72/20; H04W 72/51

(52) U.S. Cl. CPC H04W 28/0236; H04B 7/06952; H04L 1/0003; H04W 72/121; H04W 72/20; H04W 72/51

(57) ABSTRACT

Embodiments of the present disclosure provide a method for handling adjacent channel interference (ACI) from a first user equipment (UE), in an industrial environment including a plurality of industrial devices. The first UE being connected to a first network node located outside the industrial environment and each industrial device being equipped with a second UE connected to a second network node, located within the industrial environment. The method is performed by the second network node. The method includes detecting presence of the first UE within the industrial environment. The method includes determining that the first UE is causing ACI to one or more second UEs within the industrial environment. The method includes transmitting control information comprising including an indication to the one or more second UEs for causing the one or more second UEs to handle the determined ACI.

### TECHNICAL FIELD

The present disclosure relates generally to the field of wireless communication. More particularly, it relates to methods, network nodes, user equipments, UEs, and computer program products for handling adjacent channel interference, ACI in an industrial environment.

### BACKGROUND

Industrial automation is becoming increasingly popular due to rapid development in sensors, control system, and other manufacturing techniques. In industrial automation, various kinds of industrial devices (such as 6DOF robotic arms, collaborating robotic arms, Automated Guided Vehicles, AGVs, with omni-wheels, or other robotic devices) are used to automate various process in industries. For example, an industrial environment includes a plurality of industrial devices that receive control messages from a controller and perform assigned one or more operations.

In the industrial environment, the plurality of industrial devices can be equipped with a plurality of user equipments, UEs. The plurality of UEs are connected to a network node located within the industrial environment. The network node located within the industrial environment can have a different operating band compared to a network node located outside the industrial environment.

When a UE connected to the network node located outside the industrial environment enters the industrial environment, the UE has to perform an uplink, UL, transmission with a higher transmit power compared to when the UE is outside the industrial environment. The UE performs the UL transmission with the higher transmit power to reach a UL power control target of the network node located outside the industrial environment. The higher transmit power of the UE causes adjacent channel interference, ACI to the one or more UEs in the industrial environment. As a result, radio transmissions of the one or more UEs may be failed or delayed due to ACI caused by the UE.

### SUMMARY

Consequently, there is a need for an improved method and arrangement for handling adjacent channel interference, ACI, in an industrial environment that alleviates at least some of the above cited problems.

It is therefore an object of the present disclosure to provide a method, network nodes, user equipments, UEs, and a computer program product for handling adjacent channel interference, ACI in an industrial environment to mitigate, alleviate, or eliminate all or at least some of the above-discussed drawbacks of presently known solutions.

This and other objects are achieved by means of a method, a first network node, a second network node, a first user equipment, UE, a second user equipment, UE, and a computer program product as defined in the appended claims. The term exemplary is in the present context to be understood as serving as an instance, example or illustration.

According to a first aspect of the present disclosure, a method for handling adjacent channel interference, ACI, from a first user equipment, UE, in an industrial environment comprising a plurality of industrial devices. The first UE being connected to a first network node located outside the industrial environment. Each industrial device being equipped with a second UE connected to a second network node located within the industrial environment. The method is performed by the second network node. The method comprises detecting presence of the first UE within the industrial environment. The method comprises determining that the first UE is causing ACI to one or more second UEs within the industrial environment. The method comprises transmitting control information comprising an indication to the one or more second UEs for causing the one or more second UEs to handle the determined ACI.

In some embodiments, the step of determining that the first UE is causing ACI to the one or more second UEs comprises identifying at least one beam serving the one or more second UEs and suffering from ACI from the first UE. The method further comprises switching from the identified at least one serving beam suffering from ACI to another beam for serving the one or more second UEs.

In some embodiments, the step of detecting presence of the first UE within the industrial environment comprises receiving a reference signal transmitted by the first UE. The method comprises measuring a power available at a sideband of the received reference signal. The method comprises determining whether the power is greater than a pre-configured threshold. When the power has been determined to be greater than the pre-configured threshold, the method comprises detecting presence of the first UE within the industrial environment.

In some embodiments, the step of determining that the first UE is causing ACI to the one or more second UEs comprises receiving, from the one or more second UEs, a control message comprising an indication that the first UE is causing the ACI. The method further comprises receiving, from the first network node, a control message comprising an indication that the first UE is causing ACI.

In some embodiments, the control information comprising the indication to the one or more second UEs comprises one or more of: a modulation and coding scheme, MCS, on transmission of radio resources scheduled for the one or more second UEs, and an indication for the one or more second UEs to use a higher transmission power during an uplink, UL transmission.

According to a second aspect of the present disclosure, a method for handling adjacent channel interference, ACI, from a first user equipment, UE, in an industrial environment comprising a plurality of industrial devices. The first UE being connected to a first network node located outside the industrial environment. Each industrial device being equipped with a second UE connected to a second network node located within the industrial environment. The method is performed by the first network node. The method comprises detecting presence of the first UE within the industrial environment. The method comprises determining that the first UE is causing ACI to one or more second UEs within the industrial environment. The method comprises transmitting control information comprising an indication to the first UE for causing the first UE to handle the determined ACI.

In some embodiments, the step of detecting presence of the first UE within the industrial environment comprises obtaining location information of the first UE. The method comprises detecting presence of the first UE within the industrial environment using the location information of the first UE.

In some embodiments, the location information of the first UE comprises a current location of the first UE, and a moving direction of the first UE.

In some embodiments, the step of determining that the first UE is causing ACI to the one or more second UEs comprises receiving a reference signal from the first UE, which the first UE is within the industrial environment, wherein the reference signal indicates that a threshold value for ACI has been reached. The method comprises determining that the first UE is causing ACI when the reference signal is received from the first UE. The method comprises transmitting, to the second network node, a control message indicating that the first UE within the industrial environment is causing ACI to the one or more second UEs.

In some embodiments, the control information comprising the indication to the first UE comprises one or more of: an indication for the first UE to operate in a lower frequency band, an indication for the first UE to use lower transmission power during an uplink, UL, transmission, a number of first physical resource blocks, PRBs, allocated for the first UE, wherein the number of first PRBs is allocated by determining that a total transmit power consumed by the first UE for performing the UL transmission using the allocated number of first PRBs is lowered; and a number of second PRBs allocated for the first UE, wherein the number of second PRBs belong to the second network node.

According to a third aspect of the present disclosure, a method for handling adjacent channel interference, ACI, from a first user equipment, UE, in an industrial environment comprising a plurality of industrial devices. The first UE being connected to a first network node located outside the industrial environment. Each industrial device being equipped with a second UE connected to a second network node located within the industrial environment. The method is performed by the first network node. The method comprises detecting presence of the first UE within the industrial environment. The method comprises determining that the first UE is causing ACI to one or more second UEs within the industrial environment. The method comprises transmitting control information comprising an indication to the first UE for causing the first UE to handle the determined ACI.

In some embodiments, the step of detecting presence of the first UE within the industrial environment comprises receiving, from the first network node, a threshold value for ACI, wherein the reception of the threshold value for ACI indicates presence of the first UE within the industrial environment. The method comprises receiving, from the first network node, an indication indicating presence of the first UE within the industrial environment.

In some embodiments, the step of determining that the first UE within the industrial environment is causing ACI to the one or more second UEs. The method comprises measuring a transmit power during an uplink, UL, transmission. The method comprises comparing the transmit power to the threshold value for ACI received from the first network node. When the transmit power has been reached threshold value for ACI, the method comprises determining that the first UE within the industrial environment is causing ACI to the one or more second UEs.

In some embodiments, the control information comprising an indication for handling ACI comprises one or more of: an indication for the first UE to operate in a lower frequency band, an indication for the first UE to use lower transmission power during the UL transmission, a number of first physical resource blocks, PRBs, allocated for the first UE, wherein the number of first PRBs is allocated by determining that a total transmit power consumed by the first UE for performing the UL transmission using the allocated number of first PRBs is lowered, and a number of second PRBs allocated for the first UE, wherein the number of second PRBs belong to the second network node.

According to a fourth aspect of the present disclosure, a method for handling adjacent channel interference, ACI, from a first user equipment, UE, in an industrial environment comprising a plurality of industrial devices. The first UE being connected to a first network node located outside the industrial environment. Each industrial device being equipped with a second UE connected to a second network node located within the industrial environment. The method is performed by the second UE. The method comprises determining that the first UE is causing ACI to the second UE. The method comprises transmitting a control message to the second network node indicating that the first UE is causing ACI to the second UE. The method comprises receiving from the second network node, control information comprising an indication for causing the second UE to handle ACI.

In some embodiments, the step of determining that the first UE is causing ACI to the second UE comprises receiving a reference signal transmitted by the first UE, and determining that the first UE is causing ACI to the second UE by decoding the received reference signal.

In some embodiments, the control information comprising the indication for handling ACI comprises one or more of: a modulation and coding scheme, MCS, on transmission of radio resources scheduled for the second UE, and an indication to use a higher transmission power during the UL transmission.

According to a fifth aspect of the present disclosure, an apparatus of a second network node configured to operate in an industrial environment for handling adjacent channel interference, ACI, from a first user equipment, UE. The industrial environment comprising a plurality of industrial devices. The first UE being connected to a first network node located outside the industrial environment. Each industrial device being equipped with a second UE connected to the second network node located within the industrial environment. The apparatus comprising a controlling circuitry configured to cause detection of presence of the first UE within the industrial environment. The controlling circuitry is configured to cause determination of that the first UE is causing ACI to one or more second UEs within the industrial environment. The controlling circuitry is configured to transmission of control information comprising an indication to the one or more second UEs for causing the one or more second UEs to handle the determined ACI.

A sixth aspect is a second network node comprising the apparatus of the fifth aspect.

According to a seventh aspect of the present disclosure, an apparatus of a first network node configured for handling adjacent channel interference, ACI, from a first user equipment, UE in an industrial environment. The industrial environment comprising a plurality of industrial devices. The first UE being connected to the first network node located outside the industrial environment. Each industrial device being equipped with a second UE connected to a second network node located within the industrial environment. The apparatus comprising a controlling circuitry configured to cause detection of presence of the first UE within the industrial environment. The controlling circuitry is configured to cause determination of that the first UE within the industrial environment is causing ACI to one or more second UEs within the industrial environment. The controlling circuitry is configured to cause transmission of control information comprising an indication to the first UE for causing the first UE to handle the determined ACI.

An eighth aspect is a first network node comprising the apparatus of the seventh aspect.

According to ninth aspect of the present disclosure, a first user equipment, UE, configured for handling adjacent channel interference, ACI, in an industrial environment. The industrial environment comprising a plurality of industrial devices. The first UE being connected to the first network node located outside the industrial environment. Each industrial device being equipped with a second UE connected to a second network node located within the industrial environment. The first UE comprising a controlling circuitry configured to cause detection of presence of the first UE within the industrial environment. The controlling circuitry is configured to cause determination of that the first UE within the industrial environment is causing ACI to one or more second UEs within the industrial environment. The controlling circuitry is configured to cause transmission of a reference signal to one or more of: the first network node, the second network node, and the one or more second UEs. The controlling circuitry is configured to cause reception from the first network node, control information comprising an indication for handling ACI.

According to tenth aspect of the present disclosure, a second user equipment, UE, configured to operate in an industrial environment for handling adjacent channel interference, ACI. The industrial environment comprising a plurality of industrial devices. The first UE being connected to the first network node located outside the industrial environment. Each industrial device being equipped with the second UE connected to a second network node located within the industrial environment. The second UE comprising a controlling circuitry configured to cause determination of that the first UE is causing ACI to the second UE. The controlling circuitry is configured to cause transmission of a control message to the second network node indicating that the first UE is causing ACI to the second UE. The controlling circuitry is configured to cause reception, from the second network node, control information comprising an indication for causing the second UE to handle ACI.

According to an eleventh aspect of the present disclosure, there is provided a computer program product comprising a non-transitory computer readable medium, having thereon a computer program comprising program instructions. The computer program is loadable into a data processing unit and configured to cause execution of the method according to any of the first to fourth aspects when the computer program is run by the data processing unit.

In some embodiments, any of the above aspects may additionally have features identical with or corresponding to any of the various features as explained above for any of the other aspects. An advantage of some embodiments is that alternative and/or improved approaches are provided for mitigating adjacent channel interference, ACI from a first user equipment, UE, connected to a first network node located outside an industrial environment, to one or more second UEs connected to a second network node located within the industrial environment.

An advantage of some embodiment is that radio transmissions may be performed by one or more second UEs without any delay/latency in the industrial environment, due to mitigation of ACI from the first UE.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses an example communication system according to some embodiments;

FIG. 2 is a signaling diagram illustrating example signaling according to some embodiments;

FIG. 3 is a signaling diagram illustrating example signaling according to some embodiments;

FIG. 4 is a flowchart illustrating example method steps according to some embodiments;

FIG. 5 is a flowchart illustrating example method steps according to some embodiments;

FIG. 6 is a flowchart illustrating example method steps according to some embodiments;

FIG. 7 is a flowchart illustrating example method steps according to some embodiments;

FIG. 8 is a schematic block diagram illustrating an example apparatus according to some embodiments;

FIG. 9 is a schematic block diagram illustrating an example apparatus according to some embodiments;

FIG. 10 is a schematic block diagram illustrating an example apparatus according to some embodiments;

FIG. 11 is a schematic block diagram illustrating an example apparatus according to some embodiments; and

FIG. 12 discloses an example computing environment according to some embodiments.

### DETAILED DESCRIPTION

Aspects of the present disclosure will be described more fully hereinafter with reference to the accompanying drawings. The apparatus and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

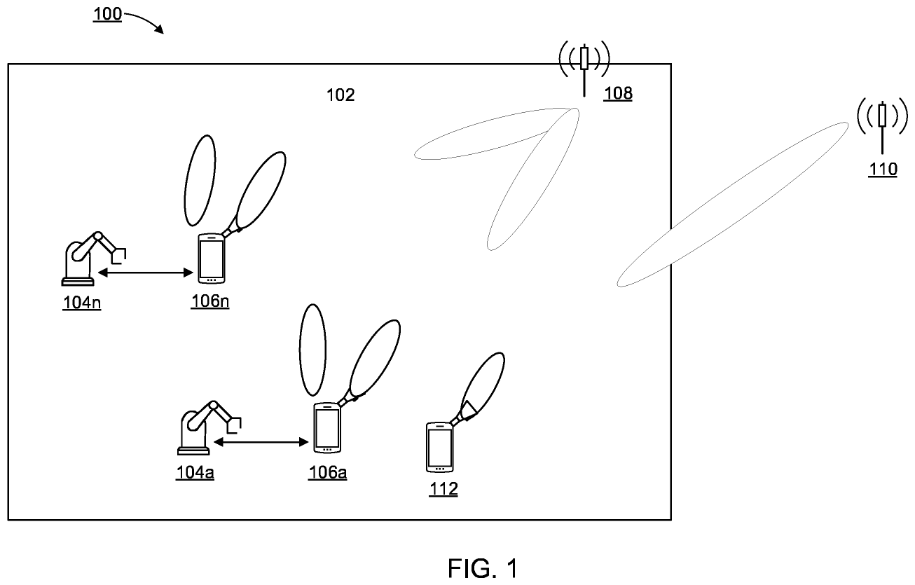

FIG. 1 discloses an example communication system 100. The communication system 100 comprises an industrial environment 102. Some of the examples of the industrial environment 102 may include a factory, a manufacturing unit, a guided robotic environment, or the like. The industrial environment 102 comprises a plurality of industrial devices 104a-104n. In some examples, the plurality of industrial devices 104a-104n may be equipped with a plurality of user equipments, UEs, 106a-106n. The plurality of UEs 106a-106n may be connected to a network node 108 located within the industrial environment 102. Further there exists a network node 110 located outside the industrial environment 102. The network node 110 may be connected to a UE 112. It should be noted that the communication system 100 is not limited to above-mentioned components, other components can also be present in the communication system 100 other than the components shown in the FIG. 1.

It should be noted that in the embodiments described herein, the network node 110 located outside the industrial environment 102 may be referred to as a first network node or a public network node 110. The network node 108 located within the industrial environment 102 may be referred to as a second network node or a private network node 108 for serving the one or more industrial devices 104a-104n within the industrial environment 102. The UE 112 connected to the first network node 110 may be referred to as a first UE 112. The UEs 106a-106n connected to the second network node 108 may be referred to as second UEs 106a-106n.

In some examples, the plurality of industrial devices 104a-104n may be a device that is stationary or mobile, and also may be referred to as a peripheral, a machinery, or the like. Examples of the plurality of industrial devices 104a-104n may include, but are not limited to, an industrial robot, a robotic arm, an automation cell, a conveyor, a lifter, a turn-over machine, an Internet of Things device, IoT device, a 6DOF robotic arm, collaborating robotic arms, Automated Guided Vehicles, AGVs, with omni-wheels, or other any other similar device.

The plurality of industrial devices 104a-104n may be connected to the plurality of second UEs 106a-106n. In some examples, the plurality of industrial devices 104a-104n may be connected to the plurality of second UEs 106a-106n using at least one of: a wired network, a cellular network, a wireless local area network, LAN, Wi-Fi, Bluetooth, Bluetooth low energy, Zigbee, Wi-Fi direct, WFD, Ultra-wideband, UWB, infrared data association, IrDA, near field communication, NFC, and so on.

The plurality of industrial devices 104a-104n may be configured to perform one or more operations in accordance with one or more control messages generated by an industrial controller (not shown). The control messages may comprise a set of commands intended for the plurality of industrial devices 104a-104n from the industrial controller. The set of commands instruct the plurality of industrial devices 104a-104n how to perform the one or more operations. The industrial controller may transmit the one or more control messages intended for the plurality of industrial devices 104a-104n to the second network node 108. The second network node 108 forwards the one or more control messages to the plurality of industrial devices 104a-104n through the plurality of second UEs 106a-106n. The plurality of industrial devices 104a-104n performs the one or more operations, upon receiving the control messages from the second network node 108 through the plurality of second UEs 106a-106n. The one or more operations performed by each of the plurality of industrial devices 104a-104n may depend on an industrial application being implemented on each of the plurality of industrial devices 104a-104n. The industrial application may include, an industrial process automation based application, a building automation based application, an application intended for monitoring electrical distribution networks, or the like.

In some examples, the first UE 112, and the plurality of second UEs 106a-106n may be a wireless device that is stationary or mobile and may also be referred to as a remote station, a mobile station, mobile equipment, a terminal, a remote terminal, an access terminal, or the like. Examples of the wireless device may include, but are not limited to, a cellular phone, a personal digital assistant, PDA, a wireless modem, a wireless communication device, a handheld device, a subscriber unit, a laptop computer, and so on.

The first UE 112 may be connected to the first network node 110 located outside the industrial environment 102. In some examples, the first UE 112 may be connected to the first network node 110 over an air interface. The first UE 112 may be configured to receive communication services provided by the first network node 110. Examples of the communication services may include, but are not limited to, a streaming service, a file download service, a carousel service, a television, TV, service, an Internet protocol, IP, multimedia subsystem, IMS, service, a short messaging service, a multimedia messaging service, MMS, and so on.

The plurality of second UEs 106a-106n may be connected to the second network node 108 located within the industrial environment 102. In some examples, the plurality of second UEs 106a-106n may be connected to the second network node 108 over an air interface.

In some examples, the plurality of second UEs 106a-106n may be configured to receive the control messages intended for the plurality of industrial devices 104a-104n from the second network node 108 and to transmit the received control messages to the plurality of industrial devices 104a-104n. In some examples, the plurality of second UEs 106a-106n may be configured to receive services from the second network node 108. The services may be defined by the industrial controller. In some examples, the services may include a mission-critical service, or the like. Examples of the mission-critical service may include, but are not limited to, a smart grid control service, smart operation of industrial automation processes, or any other service that requires different levels of security.

In some examples, the first network node 110 and the second network node 108 may be a radio node. In some examples, the radio node may include, but are not limited to, an evolved base station node, for example, an evolved node, eNB, a gNodeB, gNB, a local access network, LAN node, a wireless LAN, WLAN, node, a Wi-Fi node, or the like.

In some examples, operating frequencies associated with the first network node 110 and the second network node 108 may be overlapped. For example, the first network node 110 may operate over 3.6 GigaHertz, GHz, to 3.8 GHz, and the second network node 108 may operate over 3.5 GHz to 3.6 GHz.

In some examples, the first network node 110 and the second network node 108 may be operated by a same network operator. In some examples, the first network node 110 and the second network node 108 may be operated by a different network operator.

In some examples, the first network node 110 may belong to a public network. The public network may be a wireless communication network and also be referred to as, a public land mobile network, PLMN. Examples of the wireless communication network may include, but are not limited to, a long term evolution, LTE network, a new radio, NR/5G network, a narrowband Internet of Things, NB-IoT, network, or any other next generation network.

The first network node 110 may be configured to server one or more cells within which the one or more UEs, for example, the UE 112 may access the communication services from the first network node 110. In some examples, the industrial environment 102 may present within the one or more cells being served by the first network node. Thus, the industrial environment 102 may be present within a coverage area of the first network node 110.

In some examples, the second network node 108 may belong to a non-public network, NPN. The NPN may also be referred to as, a private network, a public network integrated NPN, or the like. The NPN may be deployed to meet and optimize coverage, performance, and security requirements of industrial processes that have been performed within the industrial environment 102. In some examples, the NPN may be deployed in conjunction with the public network. In some examples, the NPN may be deployed without requiring a support of the public network.

In some examples, the second network node 108 may be configured to receive the control messages intended for the plurality of industrial devices 104a-104n from the industrial controller and to transmit the received control messages to the plurality of industrial devices 104a-104n through the plurality of second UEs 106a-106n. In some examples, the second network node 108 may also be configured to provide the services to the one or more second UEs 106a, which have been defined by the industrial controller.

In some examples, the first network node 110 and the second network node 108 may employ directional transmissions and receptions with beamforming methods. In accordance with the beamforming methods, the first network node 110 and the second network node 108 form one or more beams for serving the first UE 112 and the plurality of second UEs 106a-106n, respectively. The first network node 110 and the second network node 108 transmit signals to the first UE 112 and the plurality of second UEs 106a-106n respectively, in the formed one or more beams. In an embodiment, the signals may be collectively referred to downlink control channel information, broadcast signals and messages, broadcast data channels, multicast and unicast data, control signals and messages, and so on.

In some examples, the second network node 108 may be associated with one or more of: an advanced antenna system, AAS, a multi-transmission and reception point, TRP, or the like for transmitting/receiving the signals to/from the one or more second UEs 106a-106n in the one or more beams.

In the communication system 100, when the first UE 112 connected to the first network node 110 enters the industrial environment 102, as depicted in FIG. 1, the first UE 112 may perform an uplink, UL, transmission, with a higher transmit power. The higher transmit power causes adjacent channel interference, ACI to the one or more second UE 106a-106n in the industrial environment 102. The ACI causes leakage of power to one or more radio channels being used by the one or more second UEs 106a-106n. The one or more radio channels being used by the one or more second UEs 106a-106n may be adjacent to a radio channel being used by the first UE 112.

Therefore, according to some embodiments of the present disclosure, the second network node 108 implements a method for efficiently handling ACI from the first UE 112 in the industrial environment 102. Furthermore, the first network node 110 implements a method for efficiently handling ACI from the first UE 112 in the industrial environment 102. Furthermore, the first UE 112 and the second UE (106a-106n) implement a method for efficiently handling ACI in the industrial environment 102.

According to some embodiments of the present disclosure, the second network node 108 detects presence of the first UE 112 within the industrial environment 102. Upon detecting presence of the first UE 112 in the industrial environment 102, the second network node 108 determines that the first UE 112 is causing ACI to the or more second UEs 106a-106n within the industrial environment 102. The second network node 108 transmits control information comprising an indication to the one or more second UEs 106a-106n for causing the one or more second UEs 106a-106n to handle the determined ACI.

According to some embodiments of the present disclosure, the first network node 110 detects presence of the first UE 112 within the industrial environment 102. The first network node 110 determines that the first UE 112 within the industrial environment 102 is causing ACI to the one or more second UEs 106a-106n within the industrial environment. Upon determining that the first UE 112 is causing ACI, the first network node 110 transmits control information comprising an indication to the first UE 112 for causing the first UE 112 to handle the determined ACI.

Various embodiments for handling ACI in the industrial environment 102 are explained in conjunction with figures in the later parts of the description.

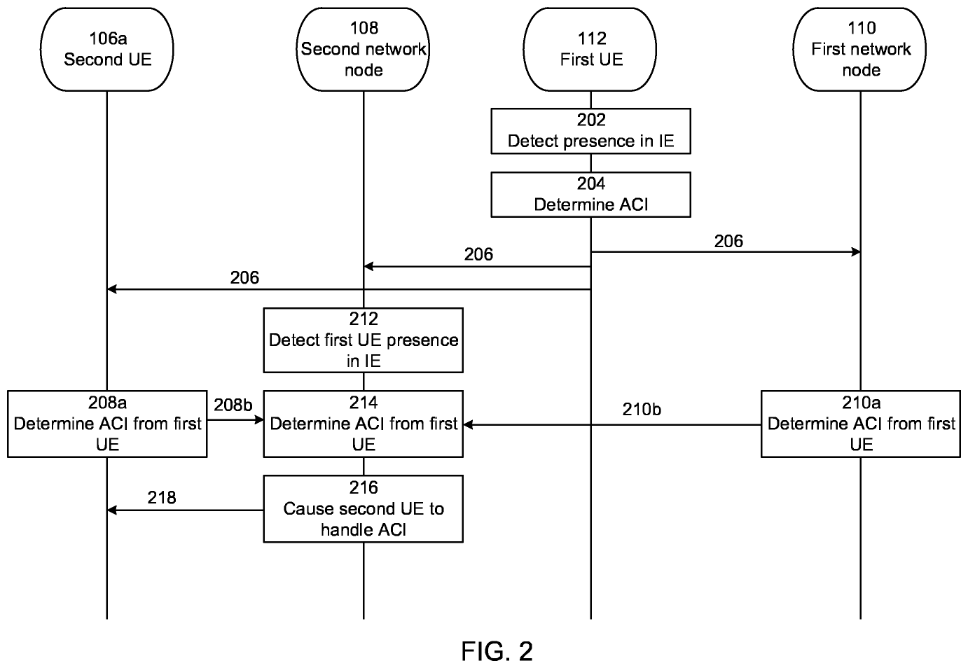

FIG. 2 is a signaling diagram illustrating example signaling for handling ACI in the industrial environment by the second network node 108. The first UE 112 connected to the first network node 110 located outside the industrial environment detects 202 presence of the first UE 112 within the industrial environment, IE.

In some embodiments, the first UE 112 determines whether a threshold value for ACI has been pre-configured to it by the first network node 110. In some examples, the threshold value for ACI may be pre-configured to the first UE 112 during a deployment phase of the industrial environment within a coverage area of the first network node 110. When it is determined that the threshold value for ACI has been pre-configured, the first UE 112 detects its presence within the industrial environment. Thus, pre-configuration of the threshold value for ACI indicates that the first UE 112 is in the industrial environment.

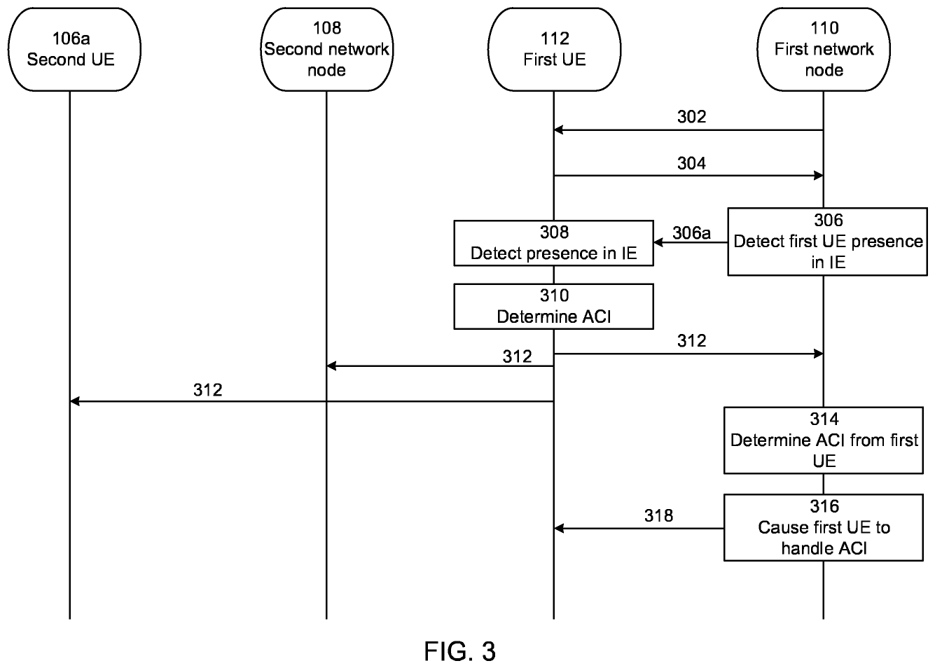

In some embodiments, the first UE 112 detects its presence within the industrial environment, upon reception of an indication from the first network node 110 (as illustrated in FIG. 3). The indication received from the first network node 110 indicates presence of the first UE 112 in the industrial environment. The first network node 110 may transmit the indication to the first UE 112 based on location information of the first UE 112. In some examples, the location information of the first UE 112 comprises a current location of the first UE 112, and a moving direction of the first UE 112.

Upon detecting presence of the first UE 112 within the industrial environment, the first UE 112 determines 204 that ACI is caused to the second UE 106a within the industrial environment. Although the embodiments described herein may be equally applicable for the plurality of second UEs connected to the second network node 108, the embodiments herein are described by considering the second UE 106a among the plurality of second UEs for which ACI has been caused from the first UE 112.

In some examples, the first UE 112 measures a transmit power while performing the UL transmission. The first UE 112 compares the transmit power with the threshold value for ACI pre-configured by the first network node 110. The first UE 112 determines that the first UE 112 is causing ACI to the second UE 106a within the industrial environment, when the transmit power has been greater than the threshold value for ACI.

When it is determined that the first UE 112 is causing ACI to the second UE 106a, the first UE 112 transmits 206 a reference signal to one or more of: the first network node 110, the second network node 108, and the second UE 106a.

In some examples, the first UE 112 may transmit the reference signal to the second UE 106a, and the first network node 110 in a physical uplink control channel, PUCCH. The reference signal may comprise of any radio signal and may also be referred to as a watch-out signal. In some examples, the radio signal may be a beacon. In some examples, the radio signal may be a sounding reference signal, SRS. In some examples, the radio signal may be any new signal defined by the first network node 110 for the first UE 112.

Upon transmission of the reference signal by the first UE 112, the second UE 106a determines 208a that the first UE 112 is causing ACI to the second UE 106a in the industrial environment.

In some examples, the second UE 106a receives the reference signal that has been transmitted by the first UE 112. The second UE 106a determines that the first UE 112 is causing ACI to the second UE 106a by decoding the received reference signal.

Upon determining that the first UE 112 is causing ACI, the second UE 106a transmits 208b a control message to the second network node 108. The control message comprises an indication indicating that the first UE 112 is causing ACI to the second UE 106a in the industrial environment.

Upon transmission of the reference signal by the first UE 112, the first network node 110 also determines 210a that the first network node 110 is causing ACI to the second UE 106a in the industrial environment. In some examples, the first network node 110 receives the reference signal that has been transmitted by the first UE 112. The first network node 110 determines that the first UE 112 is causing ACI to the second UE 106a by decoding the received reference signal.

Upon determining that the first UE 112 is causing ACI, the first network node 110 transmits 210b a control message to the second network node 108. The control message comprises an indication indicating that the first UE 112 is causing ACI to the second UE 106a in the industrial environment. It should be noted that, the steps 208a-208b, and 210a-210b may be performed in any order.

Upon transmission of the reference signal by the first UE 112, the second network node 108 detects 212 presence of the first UE 112 within the industrial environment.

In some examples, the second network node 108 receives the reference signal that has been transmitted by the first UE 112. The second network node 108 measures a power available at a sideband of the received reference signal. The second network node 108 determines whether the power is greater than a pre-configured threshold. The threshold may be pre-configured by the second network node 108. The second network node 108 detects presence of the first UE 112 within the industrial environment, when the power has been determined to be greater than the pre-configured threshold.

When it is determined that the first UE 112 is present within the industrial environment, the second network node 108 determines 214 that the first UE 112 is causing ACI to the second UE 106a within the industrial environment.

In some embodiments, the second network node 108 determines that the first UE 112 is causing ACI to the second UE 106a in accordance with the control message received from the second UE 106a (as described in the step 208b). The control message comprises the indication indicating that the first UE 112 is causing ACI.

In some embodiments, the second network node 108 determines that the first UE 112 is causing ACI to the second UE 106a in accordance with the control message received from the first network node 110 (as described in the step 210b). The control message comprises the indication indicating that the first UE 112 is causing ACI.

In some embodiments, the second network node 108 determines that the first UE 112 is causing ACI to the second UE 106a by identifying one or more beams serving the second UE 106a and suffering from ACI from the first UE 112. In some examples, the second network node 108 may determine the one or more beams suffering from ACI from the first UE 112, when the second network node 108 has been associated with one or more of: an AAS, and a multi-TRP. While determined that the one or more beams being suffering from the first UE 112, the second network node 108 switches from the identified at least one serving beam suffering from ACI to another beam for serving the second UE 106a.

Upon determining that the first UE 112 is causing ACI to the second UE 106a, the second network node 108 causes 216 the second UE 106a to handle the determined ACI. In some examples, the second network node 108 transmits 218 control information comprising an indication to the second UE 106a for causing the second UE 106a to handle the determined ACI.

In some examples, the control information comprising the indication to the second UE 106a comprises one or more of: a modulation and coding scheme, MCS, on transmission of radio resources scheduled for the second UE 106a, and an indication for the second UE 106a to use a higher transmission/transmit power during an UL transmission.

FIG. 3 is a signaling diagram illustrating example signaling for handling ACI in the industrial environment by the first network node 110. The first network node 110 located outside the industrial environment configures 302 a threshold value for ACI to the first UE 112, when the first UE 112 connects to the first network node 110. The first network node 110 may define the threshold value for ACI in accordance with a UL power control target associated with the first network node 110. The UL power control target indicates a transmit power to be consumed by the first UE 112 while performing an UL transmission.

In some examples, the threshold value for ACI may indicate the first UE 112 to transmit the reference signal to one or more of: the first network node 110, the second network node 108, and the second UE 106a, when the threshold value for ACI has been reached. Although the embodiments described herein may be equally applicable for the plurality of second UEs connected to the second network node 108, the embodiments herein are described by considering the second UE 106a among the plurality of second UEs for which the reference signal has been transmitted.

In some examples, the threshold value for ACI may also indicate presence of the industrial environment within a coverage area of the first network node 110.

In some embodiments, the first network node 110 identifies that the industrial environment is present within the coverage area of the first network node 110, when the industrial environment is present within the one or more cells being served by the first network node 110. Upon identifying that the industrial environment is present within the coverage area of the first network node 110, the first network node 110 configures the threshold value for ACI to the first UE 112.

In some embodiments, the first network node 110 identifies whether the first network node 110 has been configured with a flag. The first network node 110 may be configured with the flag, when the industrial environment has been deployed within the coverage area of the first network node 110. The flag indicates presence of the industrial environment within the coverage area of the first network node 110. Upon identifying that the first network node 110 has been configured with the flag, the first network node 110 configures the threshold value for ACI to the first UE 112.

The first network node 110 obtains 304 location information of the first UE 112. In some examples, the first network node 110 may comprise a suitable logic, for example, a digital twins for obtaining the location information of the first UE 112. In some examples, the location information of the first UE 112 comprises one or more of: a current location of the first UE 112, and a moving direction of the first UE 112.

The first network node 110 detects 306 presence of the first UE 112 within the industrial environment, IE, using the obtained location information. The first network node 110 transmits 306a an indication to the first UE 112 indicating presence of the first UE 112 within the industrial environment.

The first UE 112 detects 308 its presence within the industrial environment, in accordance with the indication received from the first network node 110.

Upon identifying presence within the industrial environment, the first UE 112 determines 310 that the first UE 112 is causing ACI to the second UE 106a in the industrial environment. In some examples, the first UE 112 measures a transmit power while performing an UL transmission. The first UE 112 determines if it is causing ACI to the second UE 106a in the industrial environment, when the transmit power has been determined to be greater than the threshold value for ACI.

When it is determined ACI is being caused to the second UE 106a, the first UE 112 transmits 312 a reference signal to one or more of: the first network node 110, the second network node 108, and the second UE 106a. In some examples, the reference signal comprises one or more of: a beacon, a SRS, or the like.

Upon transmission of the reference signal by the first UE 112, the first network node 110 determines 314 that the first UE 112 is causing ACI to the second UE 106a in the industrial environment. In some examples, the first network node 110 receives the reference signal from the first UE 112. The reference signal indicates that the threshold value for ACI has been reached.

The first network node 110 determines that the first UE 112 is causing ACI to the second UE 106a by decoding the reference signal received from the first UE 112.

The first network node 110 causes 316 the first UE 112 to handle the determined ACI. For example, the first network node 110 transmits 318 control information comprising an indication to the first UE 112 for causing the first UE 112 to handle the determined ACI.

In some examples, the control information comprising the indication to the first UE 112 comprises one or more of: an indication for the first UE 112 to operate in a lower frequency band, an indication for the first UE 112 to use lower transmission power during the UL transmission, a number of first physical resources blocks, PRBs, allocated for the first UE 112, and a number of second PRBs allocated for the first UE 112. The number of first PRBs may be allocated for the first UE by determining that a total transmit power consumed by the first UE for performing the UL transmission using the allocated number of first PRBs is lowered. The number of second PRBs may belong to the second network node 108.

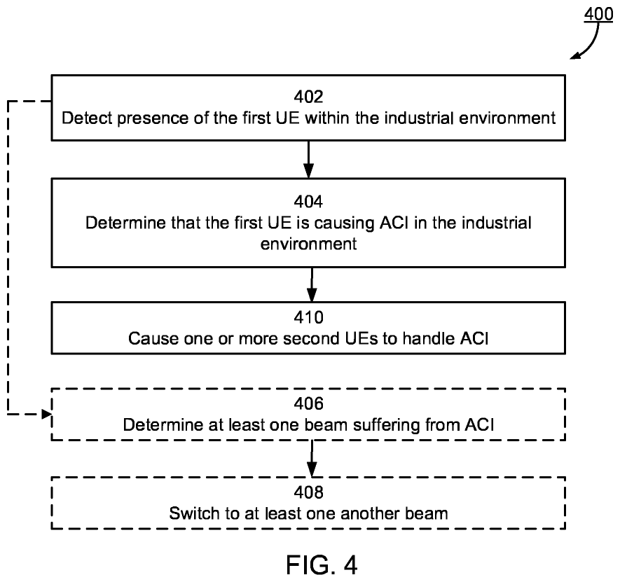

FIG. 4 is a flowchart illustrating example method steps of a method 400 performed by the second network node for handling ACI from the first UE in the industrial environment.

At step 402, the method 400 comprises detecting presence of the first UE within the industrial environment. The step 402 of detecting presence of the first UE within the industrial environment comprises receiving a reference signal transmitted by the first UE. In some embodiments, the step 402 of detecting presence of the first UE comprises measuring a power available at a sideband of the received reference signal, and determining whether the power is greater than a pre-configured threshold. When the power has been determined to be greater than the pre-configured threshold, the method 400 comprises detecting presence of the first UE within the industrial environment.

When the power has been determined to be lesser than or equal to the pre-configured threshold, the method comprises determining that the first UE is not present within the industrial environment and the reference signal transmitted by the first UE may be an indication of a false alarm. For example, when the first UE is present in an indoor environment other than the industrial environment, the first UE may transmit the reference signal to the second network node by falsely identifying that the first UE is in the industrial environment. In such a scenario, the reference signal transmitted by the first UE may be weak due to blockage of signal by one or more objects present in the indoor environment. Thus, by measuring the power of the reference signal, the second network node may be able to determine that the reference signal transmitted by the first UE is an indication of the false alarm.

Upon detecting presence of the first UE, at step 404, the method 400 comprises determining that the first UE is causing ACI to the one or more second UEs within the industrial environment. In some embodiments, the step 404 of determining that the first UE is causing ACI comprises receiving, from the one or more second UEs, a control message comprising an indication that the first UE is causing ACI. In some embodiments, the step 404 of determining that the first UE is causing ACI comprises receiving, from the first network node, a control message comprising an indication that the first UE is causing ACI.

In some embodiments, the second network node may optionally perform steps 406, and 408, upon detecting presence of the first UE in the industrial environment. At step 406, the method comprises identifying at least one beam serving the one or more second UEs and suffering from ACI from the first UE. The at least one serving beam suffering from ACI from the first UE has been identified, when the second network node comprises one or more of: an AAS, a multi-TRP, or the like.

At step 408, the method 400 comprises switching from the identified at least one serving beam suffering from ACI to another beam for serving the one or more second UEs. Thus, mitigating ACI from the first UE in the industrial environment.

For example, consider that the second network node is using three beams for serving the second UE. In such a scenario, the second network node identifies that a first beam of the three serving beams is suffering from ACI from the first UE. Upon identifying that the first beam is suffering from ACI, the second network node switches from the first beam to a second beam for serving the second UE. Thus, the second network node may avoid usage of one or more beams suffering from ACI for serving the second UE.

When it is determined that ACI is being caused to the one or more second UEs, at step 410, the method 400 comprises causing the one or more second UEs to handle the determined ACI. In some embodiments, the step 410 of causing the one or more second UEs to handle the determined ACI comprises transmitting control information comprising an indication to the one or more second UEs for causing the one or more second UEs to handle the determined ACI.

In some examples, the second network node may generate the control information based on one or more of: a direction of arrival of the reference signal from the first UE, the one or more beams suffering from ACI, and so on. The second network node may detect the direction of arrival of the reference signal from the first UE, when the second network node has been associated with one or more of: an AAS, a multi-TRP, or the like.

The control information comprising the indication to the one or more second UEs comprises one or more of: a MCS, on transmission of radio resources scheduled for the one or more second UEs, and an indication for the one or more second UEs to use a higher transmission power during an UL transmission. The MCS on transmission of the radio resources may be scheduled in a follow-up window defined for transmission of the radio resources. The indication for the one or more second UEs to use the higher transmission power during the UL transmission may be set using a power control pre-emption mechanism. In some examples, the indication set using the power control pre-emption mechanism comprises a signal alternative P0-alpha set in a downlink control information, DCI, for the one or more second UEs to use the higher transmission power.

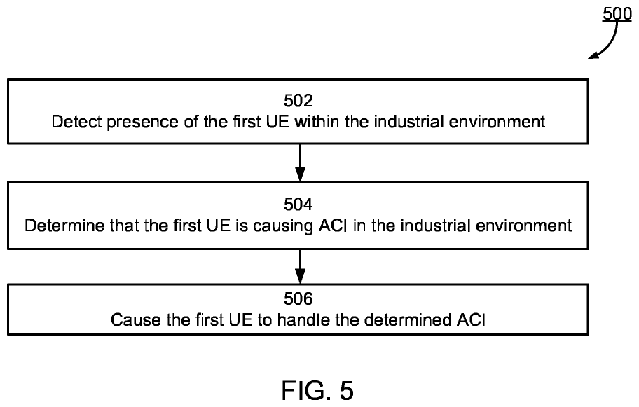

FIG. 5 is a flowchart illustrating example method steps of a method 500 performed by the first network node for handling ACI from the first UE in the industrial environment.

At step 502, the method 500 comprises detecting presence of the first UE within the industrial environment. In some embodiments, the step 502 of detecting presence of the first UE within the industrial environment comprises obtaining location information of the first UE, and detecting presence of the first UE within the industrial environment using the obtained location information of the first UE. The location information of the first UE comprises one or more of: a current location of the first UE, and a moving direction of the first UE.

At step 504, the method 500 comprises determining that the first UE is causing ACI to the one or more second UEs within the industrial environment. In some embodiments, the step 504 of determining that the first UE is causing ACI comprises receiving a reference signal from the first UE present in the industrial environment. The reference signal may comprise one or more of: a beacon, and a SRS. The reference signal may be received in a PUCCH. The reference signal indicates that a threshold value for ACI has been reached. The method comprises determining that the first UE is causing ACI, when the reference signal is received from the first UE.

At step 506, the method 500 comprises transmitting control information comprising an indication to the first UE for causing the first UE to handle the determined ACI.

In some examples, the first network node may generate the control information in such a manner that a total transmit power consumed by the first UE while performing the UL and DL transmissions using the control information is lowered.

The control information comprising the indication to the first UE comprises one or more of: an indication for the first UE to operate in a lower frequency band, an indication for the first UE to use lower transmission power during the UL transmission, a number of first PRBs allocated for the first UE, and a number of second PRBs allocated for the first UE. The number of first PRBs may be allocated for the first UE by determining that a total transmit power consumed by the first UE for performing the UL transmission using the allocated number of first PRBs is lowered. The number of second PRBs may belong to the second network node.

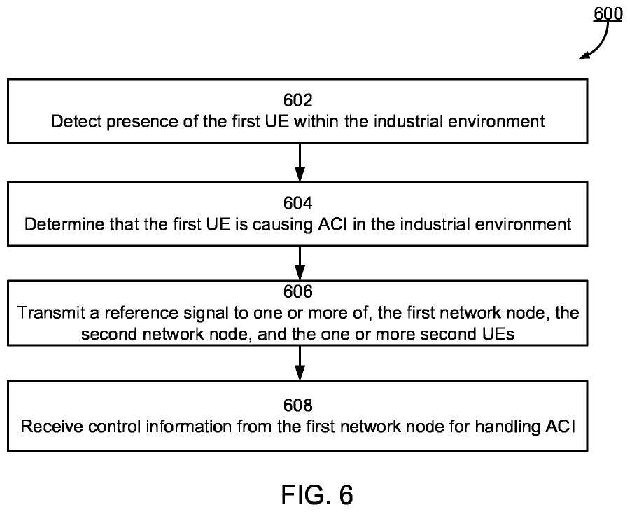

FIG. 6 is a flowchart illustrating example method steps of a method 600 performed by the first UE for handling ACI in the industrial environment.

At step 602, the method 600 comprises detecting presence of the first UE within the industrial environment.

In some embodiments, the step 602 of detecting presence of the first UE comprises using a threshold value for ACI pre-configured to the first UE 112 by the first network node 110. In some examples, the threshold value for ACI has been pre-configured to the first UE 112 during a deployment phase of the industrial environment within a coverage area of the first network node 110. In some examples, the first UE determines whether it is configured with the threshold value for ACI. When it is determined that the threshold value for ACI has been pre-configured, the first UE detects its presence within the industrial environment.

In some embodiments, the step 602 of detecting presence of the first UE comprises receiving, from the first network node, an indication indicating presence of the first UE within the industrial environment. The indication received from the first network node may indicate presence of the first UE within the industrial environment based on location information of the first UE. The location information comprises a current location of the first UE, and a moving direction of the first UE.

At step 604, the method 600 comprises determining that the first UE is causing ACI to the one or more second UEs within the industrial environment. The step 604 of determining that the first UE is causing ACI to the one or more second UEs comprises measuring a transmit power during an UL transmission. The method 600 comprises comparing the transmit power to the threshold value for ACI received from the first network node. When the transmit power has been reached the threshold value for ACI, the method 600 comprises determining that the first UE is causing ACI to the one or more second UEs.

At step 606, the method 600 comprises transmitting a reference signal to one or more of: the first network node, the second network node, and the one or more second UEs. The reference signal may comprise one or more of: a beacon, a SRS, or the like. The reference signal may be transmitted to the first network node and the one or more second UEs in a PUCCH. The reference signal indicates that the threshold value for ACI has been reached.

At step 608, the method 600 further comprises receiving, from the first network node, control information comprising an indication for handling ACI. The control information comprising the indication to the first UE comprises one or more of: an indication for the first UE to operate in a lower frequency band, an indication for the first UE to use lower transmission power during the UL transmission, a number of first PRBs allocated for the first UE, and a number of second PRBs allocated for the first UE. The number of first PRBs may be allocated for the first UE by determining that a total transmit power consumed by the first UE for performing the UL transmission using the allocated number of first PRBs is lowered. The number of second PRBs may belong to the second network node.

The control information may be used by the first UE to perform an UL transmission and a DL transmission. In some examples, the first UE may operate in the lower frequency band indicated by the first network node, while performing the UL and DL transmissions. In some examples, the first UE may perform the UL transmission by lowering the transmission power by a specific dB indicated by the first network node. In some examples, the first UE may perform the UL and DL transmissions using the first number of PRBs or the number of second PRBs allocated by the first network node.

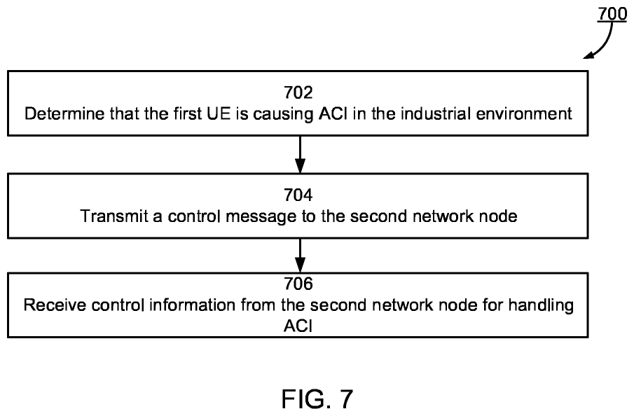

FIG. 7 is a flowchart illustrating example method steps of a method 700 performed by the second UE for handling ACI in the industrial environment.

At step 702, the method 700 comprises determining that the first UE is causing ACI to the second UE. The step 702 of determining that the first UE is causing ACI comprises receiving a reference signal transmitted by the first UE and determining that the first UE is causing ACI to the second UE in the industrial environment by decoding the reference signal. The reference signal may comprise one or more of: a beacon, and a SRS. The reference signal may be received by the second UE in a PUCCH.

At step 704, the method 700 comprises transmitting a control message to the second network node. The control message comprises an indication indicating the second network node that the first UE is causing ACI to the second UE.

At step 706, the method 700 comprises receiving, from the second network node, control information comprising an indication for causing the second UE to handle ACI. The control information comprising the indication to the second UE comprises one or more of: a MCS on transmission of radio resources scheduled for the second UE, and an indication for the second UE to use a higher transmission power during an UL transmission.

The control information may be used by the second UE to perform the UL transmission and a DL transmission. For example, the second UE may perform the UL transmission using the higher transmission power compared to transmission power consumed while performing the DL transmission. Thereby, mitigating ACI from the first UE in the industrial environment.

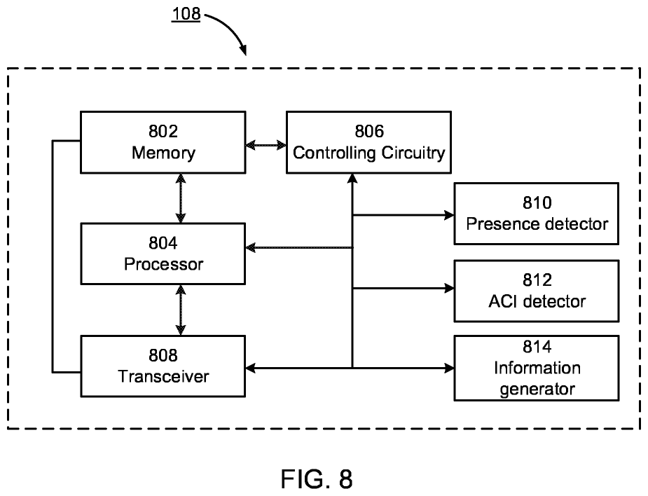

FIG. 8 is an example schematic diagram showing an apparatus 108. The apparatus 108 may e.g. be comprised in a second network node. The apparatus 108 is capable of handling ACI from the first UE in the industrial environment and may be configured to cause performance of the method 400 for handling ACI from the first UE in the industrial environment.

According to at least some embodiments of the present invention, the apparatus 108 in FIG. 8 comprises one or more modules. These modules may e.g. be a memory 802, a processor 804, a controlling circuitry 806, a transceiver 808, a presence detector 810, an ACI detector 812, and an information generator 814. The controlling circuitry 806, may in some embodiments be adapted to control the above mentioned modules.

The memory 802, the processor 804, the transceiver 808, the presence detector 810, the ACI detector 812, and the information generator 814 as well as the controlling circuitry 806, may be operatively connected to each other.

The controlling circuitry 806 may be adapted to control the steps as executed by the second network node. For example, the controlling circuitry 806 may be adapted to cause the one or more second UEs for handling ACI based on control information (as described above in conjunction with the method 400 and FIG. 4).

The transceiver 808 may be adapted to receive a reference signal transmitted by the first UE. The transceiver 808 may also be adapted to receive a control message from one or more of: the at least one second UE, and the first network node. The control message comprising an indication that the first UE is causing ACI.

The presence detector 810 may be adapted to detect presence of the first UE in the industrial environment using the received reference signal.

The ACI detector 812 may be adapted to determine that the first UE in the industrial environment is causing ACI to the one or more second UEs in the industrial environment. In some examples the ACI detector 812 determines that the first UE is causing ACI using the received control message. In some examples, the ACI detector 812 identifies at least one beam serving the one or more second UEs, and suffering from ACI from the first UE.

The information generator 814 may be adapted to generate control information comprising an indication for causing the one or more second UEs to handle the determined ACI.

In addition, the transceiver 808 may be adapted to transmit control information comprising an indication to the one or more second UEs for causing the one or more second UEs to handle the determined ACI.

Further, the processor 804 may be adapted to pre-configure a threshold, which may be used while detecting presence of the first UE in the industrial environment. The presence of the first UE in the industrial environment may be detected, when a power of the reference signal available at a sideband has been reached the threshold. The processor 804 may also be adapted to switch from the at least one serving beam to another beam for serving the one or more second UEs.

Furthermore, the memory 802 is adapted to store, the pre-configured threshold, the control message, and the control information comprising the indication to the one or more second UEs.

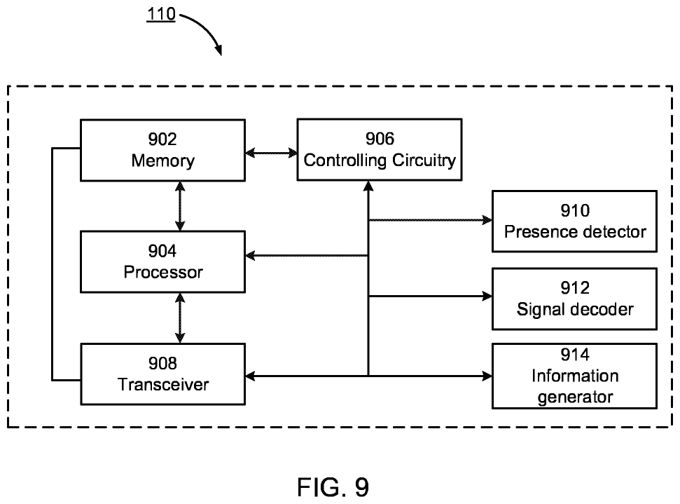

FIG. 9 is an example schematic diagram showing an apparatus 110. The apparatus 110 may e.g. be comprised in a first network node. The apparatus 110 is capable of handling ACI from the first UE in the industrial environment and may be configured to cause performance of the method 500 for handling ACI from the first UE in the industrial environment.

According to at least some embodiments of the present invention, the apparatus 110 in FIG. 9 comprises one or more modules. These modules may e.g. be a memory 902, a processor 904, a controlling circuitry 906, a transceiver 908, a presence detector 910, a signal decoder 912, and an information generator 914. The controlling circuitry 906, may in some embodiments be adapted to control the above mentioned modules.

The memory 902, the processor 904, the transceiver 908, the presence detector 910, the signal decoder 912, and the information generator 914 as well as the controlling circuitry 906, may be operatively connected to each other.

The controlling circuitry 906 may be adapted to control the steps as executed by the first network node. For example, the controlling circuitry 906 may be adapted to cause the first UE to handle ACI in the industrial environment (as described above in conjunction with the method 500 and FIG. 5).

The transceiver 908 may be adapted to receive a reference signal transmitted by the first UE. The transceiver 908 may also be adapted to receive location information of the first UE.

The presence detector 910 may be adapted to detect presence of the first UE within the industrial environment using the received location information.

The signal decoder 912 may be adapted to decode the received reference signal from the first UE to determine that the first UE is causing ACI to the one or more second UEs in the industrial environment.

The information generator 914 may be adapted to generate control information comprising an indication for the first UE to cause the first UE for handling ACI.

In addition, the transceiver 908 may be adapted to transmit one or more of: an indication to the first UE indicating presence of the first UE in the industrial environment, a control message to the second network node comprising an indication that the first UE is causing ACI, and the control information to the first UE.

Further, the processor 904 may configure a threshold value for ACI to the first UE, when the first UE connects to the first network node. The threshold value for ACI may indicate presence of the industrial environment within a coverage area of the first network node. The reference signal may be transmitted by the first UE, when the threshold value for ACI has been reached.

Furthermore, the memory 902 is adapted to store, the threshold value for ACI, the location information of the first UE, and the control information comprising the indication to the first UE.

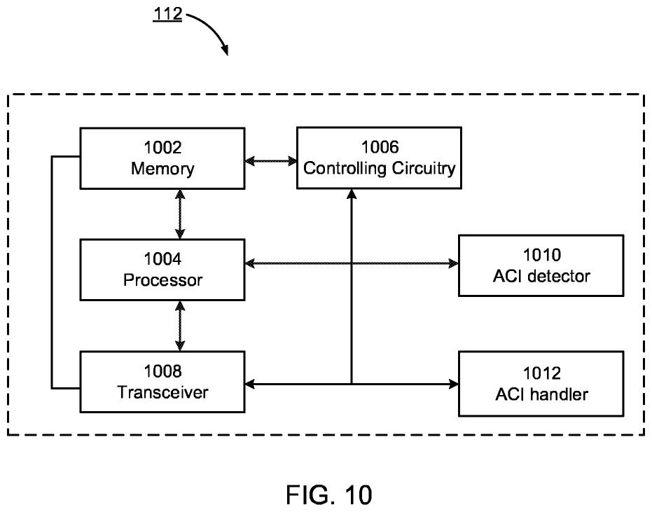

FIG. 10 is an example schematic diagram showing an apparatus 112. The apparatus 112 may e.g. be comprised in a first UE. The apparatus 112 is capable of handling ACI in the industrial environment and may be configured to cause performance of the method 600 for handling ACI in the industrial environment.

According to at least some embodiments of the present invention, the apparatus 112 in FIG. 10 comprises one or more modules. These modules may e.g. be a memory 1002, a processor 1004, a controlling circuitry 1006, a transceiver 1008, an ACI detector 1010, and an ACI handler 1012. The controlling circuitry 1006, may in some embodiments be adapted to control the above mentioned modules.

The memory 1002, the processor 1004, the transceiver 1008, the ACI detector 1010, and the ACI handler 1012 as well as the controlling circuitry 1006, may be operatively connected to each other.

The controlling circuitry 1006 may be adapted to control the steps as executed by the first UE. For example, the controlling circuitry 1006 may be adapted to handle ACI using control information received from the first network node (as described above in conjunction with the method 600 and FIG. 6).

The transceiver 1008 may be adapted to receive one or more of: a threshold value for ACI, and an indication indicating presence of the first UE in the industrial environment, from the first network node.

The ACI detector 1010 may be adapted to detect presence of the first UE in the industrial environment using the indication received from the first network node. Upon detecting presence of the first UE in the industrial environment, the ACI detector 1010 determines that the first UE is causing ACI to the one or more second UEs in the industrial environment, when the received threshold value for ACI has been reached.

Upon determining that the first UE is causing ACI, the transceiver 1008 may be adapted to transmit the reference signal to one or more of: the first network node, the second network node, and the one or more second UEs.

The transceiver 1008 may also adapted to receive the control information comprising an indication for the first UE from the first network node.

The ACI handler 1012 may be adapted to handle ACI using the control information received from the first network node.

Further, the processor 1004 may be adapted to perform UL and DL transmissions using the received control information.

Furthermore, the memory 1002 is adapted to store, the threshold value for ACI, and the control information comprising an indication for handling ACI.

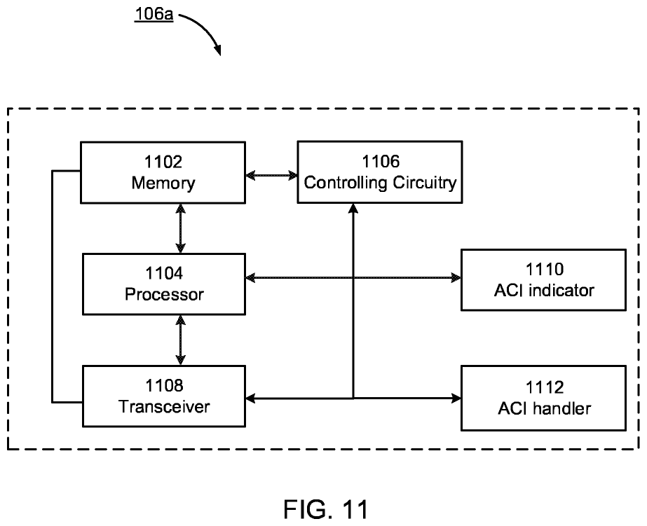

FIG. 11 is an example schematic diagram showing an apparatus 106a. The apparatus 106a may e.g. be comprised in any of the one or more second UEs connected to the second network node in the industrial environment. The apparatus 106a is capable of handling ACI from the first UE in the industrial environment and may be configured to cause performance of the method 700 for handling ACI from the first UE in the industrial environment.

According to at least some embodiments of the present invention, the apparatus 106a in FIG. 11 comprises one or more modules. These modules may e.g. be a memory 1102, a processor 1104, a controlling circuitry 1106, a transceiver 1108, an ACI indicator 1110, and an ACI handler 1112. The controlling circuitry 1106, may in some embodiments be adapted to control the above mentioned modules.

The memory 1102, the processor 1104, the transceiver 1108, the ACI indicator 1110, and the ACI handler 1112 as well as the controlling circuitry 1106, may be operatively connected to each other.

The controlling circuitry 1106 may be adapted to control the steps as executed by the second UE. For example, the controlling circuitry 1106 may be adapted to handle ACI using control information received from the second network node (as described above in conjunction with the method 700 and FIG. 7).

The transceiver 1108 may be adapted to receive a reference signal transmitted by the first UE.

The ACI indicator 1110 may be adapted to determine that the first UE is causing ACI to the second UE in the industrial environment by decoding the received reference signal.

The transceiver 1108 may be adapted to transmit a control message to the second network node comprising an indication that the first UE is causing ACI to the second UE. In response to the transmitted control message, the transceiver 110 may be adapted to receive control information from the second network node.

The ACI handler 1112 may be adapted to handle ACI from the first UE using the control information received from the second network node.

Further, the processor 1104 may be adapted to perform UL and DL transmissions using the received control information.

Furthermore, the memory 1102 is adapted to store the control information comprising an indication for handling ACI.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors, DSPs, special-purpose digital logic, and the like. The processing circuitry may be configured to execute program code stored in memory, which may include one or several types of memory such as read-only memory (ROM), random-access memory, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

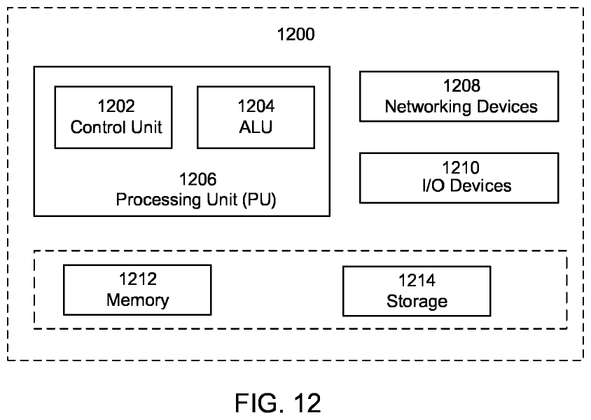

FIG. 12 illustrates an example computing environment 1200 implementing a method and the second network node, the first network node, the first UE, and the second UE, as described in FIG. 4, FIG. 5, FIG. 6, and FIG. 7. As depicted in FIG. 12, the computing environment 1200 comprises at least one data processing module 1206 that is equipped with a control module 1202 and an Arithmetic Logic Unit (ALU) 1204, a plurality of networking devices 1208 and a plurality Input output, I/O devices 1210, a memory 1212, a storage 1214. The data processing module 1206 may be responsible for implementing the method described in FIG. 4, FIG. 5, FIG. 6, and FIG. 7. For example, the data processing module 1206 may in some embodiments be equivalent to the processor of the second network node, the first network node, the first UE, and the second UE described above in conjunction with the FIGS. 1-11. The data processing module 1206 is capable of executing software instructions stored in memory 1212. The data processing module 1206 receives commands from the control module 1202 in order to perform its processing. Further, any logical and arithmetic operations involved in the execution of the instructions are computed with the help of the ALU 1204.

The computer program is loadable into the data processing module 1206, which may, for example, be comprised in an electronic apparatus (such as the second network node, the first network node, the first UE, and the second UE). When loaded into the data processing module 1206, the computer program may be stored in the memory 1212 associated with or comprised in the data processing module 1206. According to some embodiments, the computer program may, when loaded into and run by the data processing module 1206, cause execution of method steps according to, for example, the method illustrated in FIG. 4, FIG. 5, FIG. 6, and FIG. 7 or otherwise described herein.

The overall computing environment 1200 may be composed of multiple homogeneous and/or heterogeneous cores, multiple CPUs of different kinds, special media and other accelerators. Further, the plurality of data processing modules 1206 may be located on a single chip or over multiple chips.

The algorithm comprising of instructions and codes required for the implementation are stored in either the memory 1212 or the storage 1214 or both. At the time of execution, the instructions may be fetched from the corresponding memory 1212 and/or storage 1214, and executed by the data processing module 1206.

In case of any hardware implementations various networking devices 1208 or external I/O devices 1210 may be connected to the computing environment to support the implementation through the networking devices 1208 and the I/O devices 1210.

The embodiments disclosed herein can be implemented through at least one software program running on at least one hardware device and performing network management functions to control the elements. The elements shown in FIG. 12 include blocks which can be at least one of a hardware device, or a combination of hardware device and software module.

1. A method for handling adjacent channel interference (ACI) from a first user equipment (UE) in an industrial environment, the industrial environment comprising a plurality of industrial devices, the first UE being connected to a first network node located outside the industrial environment and each industrial device, being equipped with a second UE connected to a second network node located within the industrial environment, the method being performed by the second network node, the method comprising:
detecting presence of the first UE within the industrial environment;
determining that the first UE is causing ACI to one or more second UEs within the industrial environment; and
transmitting control information comprising an indication to the one or more second UEs for causing the one or more second UEs to handle the determined ACI.

2. The method according to claim 1, wherein the determining that the first UE is causing ACI to the one or more second UEs comprises:
identifying at least one beam serving the one or more second UEs and suffering from ACI from the first UE; and
the method further comprising: switching from the identified at least one serving beam suffering from ACI to another beam for serving the one or more second UEs.

3. The method according to claim 1, wherein the determining that the first UE is causing ACI to the one or more second UEs comprises one or more of:
receiving, from the one or more second UEs, a control message comprising an indication that the first UE is causing ACI; and
receiving, from the first network node, a control message comprising an indication that the first UE is causing ACI.

4. The method according to claim 1, wherein the detecting presence of the first UE within the industrial environment comprises:
receiving a reference signal transmitted by the first UE;
measuring a power available at a sideband of the received reference signal;
determining whether the power is greater than a pre-configured threshold; and
detecting presence of the first UE within the industrial environment when the power has been determined to be greater than the pre-configured threshold.

5. The method according to claim 1, wherein the control information comprising the indication to the one or more second UEs comprises one or more of:
a modulation and coding scheme (MCS) on transmission of radio resources scheduled for the one or more second UEs; and
an indication for the one or more second UEs to use a higher transmission power during an uplink (UL) transmission.

6. A method for handling adjacent channel interference (ACI) from a first user equipment (UE) in an industrial environment, the industrial environment comprising a plurality of industrial devices, the first UE being connected to a first network node located outside the industrial environment and each industrial device, being equipped with a second UE connected to a second network node, located within the industrial environment, the method being performed by the first network node, the method comprising:
detecting presence of the first UE within the industrial environment;
determining that the first UE is causing ACI to one or more second UEs within the industrial environment; and
transmitting control information comprising an indication to the first UE for causing the first UE to handle the determined ACI.

7. The method according to claim 6, wherein the detecting presence of the first UE within the industrial environment comprises:
obtaining location information of the first UE; and
detecting presence of the first UE within the industrial environment using the location information of the first UE.

8. The method according to claim 7, wherein the location information of the first UE comprises a current location of the first UE, and a moving direction of the first UE.

9. The method according to claim 6, wherein the determining that the first UE is causing ACI to the one or more second UEs comprises:
receiving a reference signal from the first UE, which the first UE is within the industrial environment, wherein the reference signal indicates that a threshold value for ACI has been reached; and
determining that the first UE is causing ACI when the reference signal is received from the first UE.

10. The method according to claim 9, further comprising:
transmitting, to the second network node, a control message indicating that the first UE within the industrial environment is causing ACI to the one or more second UEs.

11. The method according to claim 6, wherein the control information comprising the indication to the first UE comprises one or more of:
an indication for the first UE to operate in a lower frequency band;
an indication for the first UE to use lower transmission power during an uplink (UL) transmission;
a number of first physical resource blocks (PRBs) allocated for the first UE, wherein the number of first PRBs is allocated by determining that a total transmit power consumed by the first UE for performing the UL transmission using the allocated number of first PRBs is lowered; and
a number of second PRBs allocated for the first UE, wherein the number of second PRBs belong to the second network node.

12. A method for handling adjacent channel interference (ACI) from a first user equipment (UE) in an industrial environment, the industrial environment comprising a plurality of industrial devices, the first UE being connected to a first network node located outside the industrial environment and each industrial device, being equipped with a second UE connected to a second network node, located within the industrial environment, the method being performed by the first UE, the method comprising:
detecting presence of the first UE within the industrial environment;
determining that the first UE is causing ACI to one or more second UEs within the industrial environment;
transmitting a reference signal to one or more of: the first network node, the second network node, and the one or more second UEs; and
receiving, from the first network node, control information comprising an indication for handling ACI.

13. The method according to claim 12, wherein the detecting presence of the first UE within the industrial environment comprises one or more of:
receiving, from the first network node, a threshold value for ACI, wherein the reception of the threshold value for ACI indicates presence of the first UE within the industrial environment; and
receiving, from the first network node, an indication indicating presence of the first UE within the industrial environment.

14. The method according to claim 12, wherein the determining that the first UE is causing ACI to the one or more second UEs comprises:
measuring a transmit power during an uplink (UL) transmission;
comparing the transmit power to the threshold value for ACI, received from the first network node; and
determining that the first UE within the industrial environment is causing ACI to the one or more second UEs, when the transmit power has been reached the threshold value for ACI.

15. The method according to claim 12, wherein the control information comprising an indication for handling ACI comprises one or more of:
an indication for the first UE to operate in a lower frequency band;
an indication for the first UE to use lower transmission power during the UL transmission;
a number of first physical resource blocks (PRBs) allocated for the first UE, wherein the number of first PRBs is allocated by determining that a total transmit power consumed by the first UE for performing the UL transmission using the allocated number of first PRBs is lowered; and
a number of second PRBs allocated for the first UE, wherein the number of second PRBs belong to the second network node.

16. A method for handling adjacent channel interference (ACI) from a first user equipment (UE) in an industrial environment, the industrial environment comprising a plurality of industrial devices, the first UE being connected to a first network node located outside the industrial environment and each industrial device, being equipped with a second UE connected to a second network node, located within the industrial environment, the method being performed by the second UE, the method comprising:
determining that the first UE -is causing ACI to the second UE (106a);
transmitting a control message to the second network node indicating that the first UE is causing ACI to the second UE; and
receiving, from the second network node, control information comprising an indication for causing the second UE to handle ACI.

17. The method according to claim 16, wherein the determining that the first UE is causing ACI to the second UE comprises:
receiving a reference signal transmitted by the first UE; and
determining that the first UE is causing ACI to the second UE by decoding the received reference signal.

18. The method according to claim 16, wherein the control information comprising the indication for handling ACI comprises one or more of:
a modulation and coding scheme (MCS) on transmission of radio resources scheduled for the second UE; and
an indication to use a higher transmission power during an uplink (UL) transmission.

19-39. (canceled)
